(19) United States
(12) Patent Application Publication
(10) Pub. No.: US 2022/0317635 A1
(43) Pub. Date: Oct. 6, 2022

(54) SMART ECOSYSTEM CURIOSITY-BASED SELF-LEARNING

(71) Applicant: International Business Machines Corporation, Armonk, NY (US)

(72) Inventors: Clement Decrop, Arlington, VA (US); Tushar Agrawal, West Fargo, ND (US); Jeremy R. Fox, Georgetown, TX (US); Sarbajit K. Rakshit, Kolkata (IN)

(21) Appl. No.: 17/223,484

(22) Filed: Apr. 6, 2021

(51) Int. Cl. G05B 13/02; G16Y 10/75; G05B 13/04

(52) U.S. Cl. CPC G05B 13/0265; G16Y 10/75; G05B 13/048

(57) ABSTRACT

A processor may receive a submission of a command. The processor may analyze the command for at least one commonality with a previous command and predict a predicted reason for the submission of the command based on historical learning. The processor may integrate the predicted reason into a corpus specific to a user, wherein the corpus includes user preference data, and wherein the processor predicts one or more orders of the user using the corpus.

### BACKGROUND

The present disclosure relates to smart devices, and more specifically, to personalization of smart devices.

Machine learning is becoming a prevalent tool in technology. Machine learning is capable of automatically updating and improving functions of devices through the analysis of data and associations. Additionally, smart devices are used to perform various commands. Some commands are capable of being predicted, and predictions may enhance user experience.

### SUMMARY

Embodiments of the present disclosure include a method, system, and computer program product for curiosity-based self-learning of a smart ecosystem. In some embodiments, a processor may receive a submission of a command. The processor may analyze the command for at least one commonality with a previous command and predict a predicted reason for the submission of the command based on historical learning. The processor may integrate the predicted reason into a corpus specific to a user, wherein the corpus includes user preference data, and wherein the processor predicts one or more orders of the user using the corpus.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a diagram of a smart ecosystem with curiosity-based self-learning in accordance with embodiments of the present disclosure.

FIG. 2 depicts an orchestration flow a smart ecosystem with curiosity-based self-learning in accordance with embodiments of the present disclosure.

FIG. 3 illustrates a block diagram of an example computing environment in which illustrative embodiments of the present disclosure may be implemented.

FIG. 4 depicts a block diagram of an example natural language processing system configured to analyze a recording to identify a particular subject of a query in accordance with embodiments of the present disclosure.

FIG. 5 illustrates a cloud computing environment according to an embodiment of the present invention.

FIG. 6 depicts abstraction model layers according to an embodiment of the present invention.

FIG. 7 illustrates a high-level block diagram of an example computer system that may be used in implementing one or more of the methods, tools, and modules, and any related functions, described herein, in accordance with embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to smart devices, and more specifically, to personalization of smart devices. Embodiments of the present disclosure include a method, system, and computer program product for curiosity-based self-learning of a smart ecosystem.

Smart ecosystems are systems that may include one or more smart devices. Smart ecosystems may adapt by integrating information into a database and changing behavior based on the newly incorporated data. This information may be preloaded (e.g., by a product provider), manually input (e.g., by a user), automatically collected (e.g., the system stores commands and/or command patterns), or some combination thereof. Such a database may be enhanced by including reasoning in the database to enable a smart ecosystem to understand why a particular action was taken and thereby potentially replicate that action under the same or similar circumstances.

Various devices may be incorporated into a smart ecosystem. For example, a smart ecosystem may include various internet of things (IoT) devices using data stored in a connected hub having access to a corpus of user data. Data in the corpus may include, for example, time and temperature settings for a thermostat, alarm settings for a clock, cook temperature and time for an oven, and/or time and brightness settings for one or more lights. Data may be entered into the corpus manually (e.g., a user may identify settings for a device via an application on a smartphone), semi-automatically (e.g., a device may prompt a user for a specific setting), automatically (e.g., preloaded settings), or some combination thereof.

In some embodiments of the present disclosure, a user may opt-in to a smart ecosystem predictive service to permit a smart ecosystem to collect data to make predictions and automate some or all of the user experience. For example, one or more IoT devices may glean data from settings selected by a user to predict the settings that user will want in the same or similar circumstances and set predicted settings to reflect anticipated user preference.

In an IoT system, all devices may be uniquely identified. Devices may communicate with one another to implement user decisions. For example, a user may give a command to a smart ecosystem control center (e.g., a hub) to turn off the lights in the kitchen at 9 pm, and the control center may communicate to the lights in the kitchen to turn off at 9 pm. Additionally, information can be fed from individual IoT devices to other IoT devices. For example, a user may indicate that a toaster is to start toasting three minutes after coffee brewing is commenced; when the user starts the coffee maker, the coffee maker may communicate to the toaster when it starts brewing to start toasting in three minutes. IoT devices may communicate directly (e.g., the coffee maker may communicate directly with the toaster) or indirectly (e.g., the coffee maker may communicate with the toaster via a hub or database).

A user may opt in to an IoT system that collects command data to anticipate future user desires. That user may input various commands, and those commands may be tracked by the IoT system. The smart ecosystem may track information such as, for example, how the user submitted the command, when the user submitted the command, where a user submits a command, and other context such as circumstances surrounding given commands.

How a user submits commands may include, for example, whether a user submits commands via voice, text, and/or physical gesture. Some IoT systems may accept commands via natural language processing (NLP) commands; for example, a user may vocally tell a smart ecosystem to close a window. Some IoT systems may accept commands via text input; for example, a user may direct the system to close the window via a user interface such as a smartphone application. Some IoT systems may accept commands via physical gesture; for example, a user may communicate with a system via sign language, or a user may indicate certain gestures as shorthand for performing specified functions.

When a user submits a command may be an absolute time or a relative time. An absolute time for a command may be, for example, that at 11 pm on Monday a user commands the smart ecosystem to turn off all lights inside an apartment. (Such a command may exclude, for example, lights hanging on a balcony.) A relative time for a command may be, for example, a time in relation to another action or command. For example, a relative time may be that the lights in a conference room are to be turned on one hour after the lobby lights are switched on. In another example, a relative time may be that a toaster is to start toasting five minutes after a coffee grinder starts grinding coffee beans.

Where a user submits a command may indicate the device a user submits a command through (e.g., a control hub versus a smartphone) or a physical location (e.g., a couch in the living room.) Physical location data may include, for example, whether the user is on site (e.g., in the living room and giving a command to turn on the television in the living room) or off site (e.g., returning from a trip and giving a command to turn on a driveway light).

Contextual information may include circumstances surrounding given commands. Context may include, for example, what IoT devices are part of the smart ecosystem, current and/or recent actions of connected IoT devices, day of the week, user mood, environmental settings and/or conditions, recent commands, expected commands, presence of others (e.g., putting a device on speaker phone for a conference call, providing white noise for a privacy, et cetera), one or more user interactions with social media, media selection, weather data, and the like.

For example, a smart ecosystem may include a weather notification device, a television, and a set of lights; the weather notification system may identify stormy weather outside expected to continue for three hours, the user may be watching a movie on the television, and the lights may be turned off. In accordance with the present disclosure, the smart ecosystem may correlate stormy weather, movie watching, and the lights being turned off.

In some embodiments, contextual information may include the reason a user selected a certain setting or submitted a certain command. The smart ecosystem may collect reasoning data from the user (e.g., requesting a reason for a command) and include the reason into the database (e.g., entering an in-then statement into a corpus to indicate that certain conditions will trigger a certain command) to better future predictions. For example, a system may predict a user to submit a command to turn off a light; if the user does not submit a command to turn off the light when expected, the system may prompt the user for a reason, and the user may explain to the system that the user does not want the light off because friends are coming over for game night. The system may integrate the reason into its database to better forecast when the user will want the light left on (e.g., when a linked calendar indicates visitors for game night) and when the user will want the light turned off.

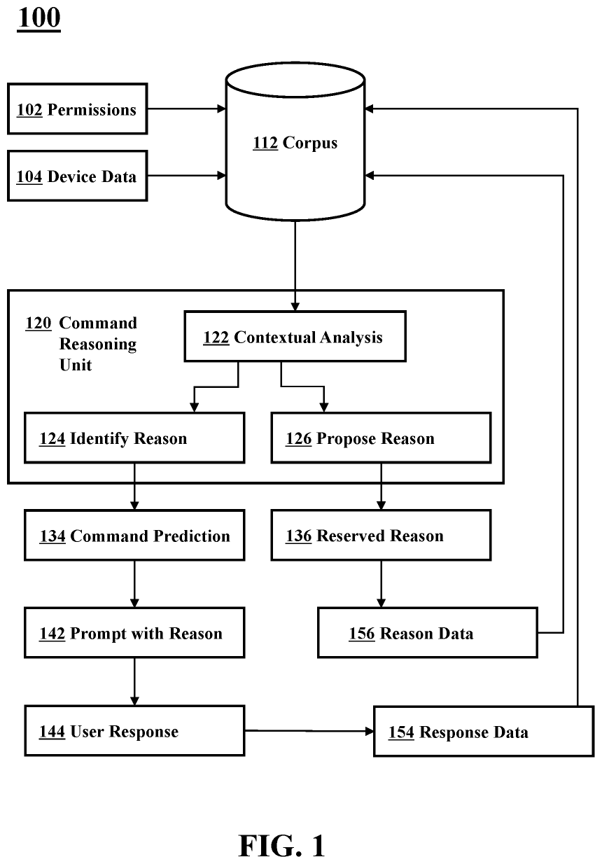

FIG. 1 illustrates a diagram of a smart ecosystem with curiosity-based self-learning 100 in accordance with embodiments of the present disclosure. A user may grant permissions 102 for a smart ecosystem to collect device data 104 and aggregate the collected information in a corpus 112. Data, including permissions 102 and device data 104, may be submitted to the corpus 112 and thereby made available to the smart system.

The corpus 112 in the smart ecosystem may be in communication with a command reasoning unit 120. The command reasoning unit 120 may be part of, for example, a processor or a smart device. The command reasoning unit 120 performs contextual analysis 122 to predict the reasoning for a given command. The command reasoning unit 120 may identify a reason 124 for the given command and develop a command prediction 134. The command reasoning unit 120 may prompt the user with a reason 142 to determine whether the command reasoning unit 120 correctly identified the reason 124. The user may then provide a user response 144. The user response 144 may be submitted to the corpus 112 as response data 154.

The command reasoning unit 120 may perform contextual analysis 122 to propose a reason 126. The proposed reason 126 may be retained as a reserved reason 136. The reserved reason 136 may be submitted to the corpus 112 as reason data 156.

The contextual analysis 122 performed by the command reasoning unit 120 may include the analysis of scenarios, such as contextual scenarios, to generate relevant data. A smart ecosystem may identify contextual scenarios by identifying one or more indicators to identify reasoning for a submission of a command at a given time. Contextual analysis may include information collected by devices on the IoT network (e.g., temperature sensors on a thermostat), external data sources (e.g., a weather website), a compilation of data and/or metadata stored in the corpus 112, or some combination of these or other sensors the user grants permission for the system to use to collect data.

For example, a user may habitually open windows shortly after waking up each morning but does not open the windows on a particular day. The system may collect weather data from a website and postulate that the user decided to not open the windows on that day because it was raining. The system could prompt the user with the reason 142 to request whether the system properly understood why the user did not open the window. The user may provide a user response 144 to indicate the reason for the window being closed. If the system was incorrect in its assessment, the user could identify the correct reason for not opening the window. In some embodiments, the system could prompt the user for a reason for not opening the window, and the user may provide an additional user response 144 indicating the reason for not opening the window. The system may prompt the user with a free-form question (e.g., “Why is the window still closed?”), a true-or-false question (e.g., “Is the window closed because it is raining?”), or a multiple-choice question (e.g., “Is the window closed (A) because it is raining, (B) because it is cold, or (C) because it is windy?”). The user response 144 may be submitted to the corpus 112 as response data 154 and used to improve predictions in the future.

Contextual analysis may include mood analysis. Mood analysis may integrate mood data into the corpus 112. For example, the user may have a habit of making coffee when tired in the morning, and the smart ecosystem may offer to start brewing a fresh pot of coffee upon detecting the user yawning in the morning. Mood analysis may consider factors such as mood detection, tone of voice analysis, sentimental analysis, empathy analysis, social media interaction, and the like.

Various types of sensors may provide numerous types of input to enable mood analysis. For example, some devices on the IoT network may have microphones, and the user may permit the microphones to be used to collect information for mood analysis. The microphones may collect metadata about user commands such as slowness of speech when the user is tired or high-pitched tones when the user is frustrated. Such data may then be used, for example, to predict that a user will turn off lights when tired or to play soothing music when frustrated.

Thus, a system may identify correlations between data points as commands having one or more commonalities. For example, if a user turns on the television at 6:55 pm and watches the 7 pm news then turns the television off, the system may identify the context of the 7 pm news program as a commonality for turning on the television. Similarly, the system may identify that the user has a history of commands for turning the lights on at 6 am on weekdays; the commonality for the lights being turned on for this user is 6 am.

A system may learn by integrating data into the corpus 112. The system could learn user preferences and commands over time and in context of various circumstances. Learning data based on previous preferences, commands, settings, and similar may be referred to as historical learning because it is based on the history of use of the system by the user. Historical learning may be used to predict how a user will react to a given situation (e.g., what commands the user will give in that situation) and may enabling the system preemptively suggesting a command or proactively executing the command.

For example, via historical learning, a system may learn that a user keeps the windows open if the temperature outside is predicted by a weather service to be between 70°-80° Fahrenheit, the chance of precipitation is less than 15%, and winds are expected to be less than 5 mph, and that any of these conditions not being met results in the user closing the windows. The data may be collected as numerous individual data points (e.g., every time the window is open or closed is a data point containing environmental data) collected to observe user trends (e.g., closing the window at 87° Fahrenheit, or if there is a 20% chance of precipitation, or when wind gusts are expected to reach 9 mph). The system may pull data from a local weather station to identify an incoming storm and anticipate a user command to close the windows by offering to close the window because the temperature is expected to fall to 57° Fahrenheit.

The system may incorporate feedback as part of the data in the corpus 112. The system may prompt the user with a suggested command, and the user may, for example, offer a user response 144 that declines the command because of another factor. For example, if the temperature is expected to drop to 57° Fahrenheit overnight but is expected to return to 70° Fahrenheit by daybreak, the user may identify it as an adequate evening temperature for the windows remaining open. The system may then integrate that information into the corpus 112 and recognize 70°-80° Fahrenheit as the daytime temperature range for open windows and 57°-80° Fahrenheit as the nighttime temperature range for open windows.

In some embodiments, the system may gradually adapt to the anticipated user commands. For example, a user may indicate that the lights in the living room should be turned off by 8 pm, has a history of preferring lights to be dimmed gradually, and has identified to the system that it prefers gradual dimming of lights to reduce eye strain. The system may thus gradually turn off the lights by dimming the lights at 7:30 pm (and perhaps also dims the lights further at 7:40 pm and 7:50 pm) and then turning the lights off at 8 pm.

A system may predict user commands via commonality with a previous command. A commonality with a previous command may be, for example, that the user previously submitted one or more commands for the lights to be dimmed before turning the lights off; thus, the system may dim the lights before turning the lights off after every command by the user to turn off the lights because of the commonality of dimming the lights in prior commands to dim the lights prior to turning the lights off. The system may automatically integrate the light-dimming preference (e.g., dim the lights whenever a command to turn the lights off is issued) or may prompt the user with an inquiry as to whether the user would prefer to dim the lights before turning the lights off.

In some embodiments, a system may be able to detect (e.g., via mood analysis) whether a user is frustrated with the system and the system may default to an action instead of asking the user for additional input. For example, a system may ask the user a number of questions when first beginning to personalize the system for the user, and the user may become frustrated with the questions and instead want the system to stop asking questions and simply perform submitted commands; the system may detect the frustration of the user using tonal analysis and decrease the frequency of the inquiries or eliminate inquiries entirely until the tonal analysis indicates that the user is calm and has not been frustrated within the previous hour. In some embodiments, the time frame for decreased/eliminated inquiries may increase with repeated instances of frustration; for example, the system may pause reasoning prompts for an hour in the first instance, pause reasoning prompts for three hours in the second instance, and pause reasoning prompts for ten hours in the third instance. The frustration instances count and its corresponding pauses may continue indefinitely, reach a maximum (e.g., go a maximum of one month of pausing the reasoning prompt), may reset at a certain point (e.g., after a week has passed since the first instance, or after ten instances), or some combination thereof.

In some embodiments (such as a system with a high degree of confidence that the user will want a particular action performed), the system may perform the predicted actions. For example, the system may dim the lights upon a command to turn the lights off if the user has a preference of dimming lights prior to turning them off. The system may perform corrective action if necessary. For example, the user may command the system to immediately turn off the lights without dimming then first. In some embodiments (such as with a system without enough data to predict user preference with a high degree of confidence), the system may only perform the expressly indicated task. For example, if a system has a 57% degree of confidence that the user will want the lights dimmed before turning them off, the system may follow only the command given and turn out the light without dimming it.

The confidence of a system may be calculated via any means in the art, whether currently known or later to be developed. Whether a system has a high degree of confidence or a low degree of confidence in a prediction may be based on the application, the predictive mechanisms, and thresholds set based on varying needs. For example, a system may have a high degree of confidence of dimming the lights before turning the lights off if predicted with 73% confidence whereas the same system may require a higher confidence threshold of 85% of window closure; in such a system, an 80% confidence in a light dimming prediction and an 80% confidence in a window closure prediction may result in the system automatically dimming the lights and waiting for the user to issue a command to close the windows.

Confidence thresholds and degrees of confidence in predictions may differ between commands, types of commands, times of day, day of the week, or any number of factors. In some embodiments, confidence thresholds may be similar or the same across certain commands, certain types of commands, an entire system, any component thereof, or any combination thereof.

In some embodiments, thresholds may be tiered such that a certain confidence threshold initiates a system prompt and a certain threshold results in the system automatically executing the predicted action. For example, a system may have a first threshold of 70% confidence for prompting a user for a certain command and a second threshold of 93% confidence for performing the command without the user needing to issue the command; such a system may prompt the user for the command to turn on jazz music if a prediction for turning on jazz music is 75% and may simultaneously turn on the lights automatically (e.g., without user input) because the prediction that the user will want the lights turned on has a 94% confidence.

In some embodiments, data collected from the profiles of various users may be aggregated to predict whether a user will issue a particular command in a certain context. For example, a smart ecosystem may find several points of commonality between a pool of users and use those points of commonality to predict commands from one or more of the users. For example, a group of users may start the day at 7 am and turn off all inside lights around midnight; the smart ecosystem may predict that another user who starts the day at 7 am may turn off all inside lights around midnight.

Cross-profile predictions may include data from one or more other users based on similar user profiles. User profiles may include, for example, user command history, one or more user preferences, system predictions for the user based on user data, feedback and/or responses from the user, and other information that may be used to predict user commands.

In some embodiments, the curiosity-based self-learning of a smart ecosystem may receive, by a processor, a submission of a command. The processor may analyze the command for at least one commonality with a previous command and predict a predicted reason for the submission of the command based on historical learning. The processor may integrate the predicted reason into a corpus specific to a user, wherein the corpus includes user preference data, and wherein the processor predicts one or more orders of the user using the corpus.

Some embodiments may include prompting the user for a validated reason, wherein the validated reason overwrites the predicted reason in the corpus. Some embodiments may include receiving feedback from the user and incorporating the feedback into the corpus. Some embodiments may include requesting the feedback from the user in response to the user not requesting the one or more orders predicted by the processor.

In some embodiments, the processor may be a smart device which may be part of an internet of things device network. The internet of things device network may use historical learning from one or more internet of things data feeds.

Some embodiments may include prompting the user for a predicted command based on the corpus. Some embodiments may further include adapting to the feedback by adjusting frequency of requests for the feedback. Some embodiments may include incorporating mood analysis into the predicted reason. Some embodiments may include analyzing the command to identify at least one commonality with a previous command includes identifying a contextual scenario.

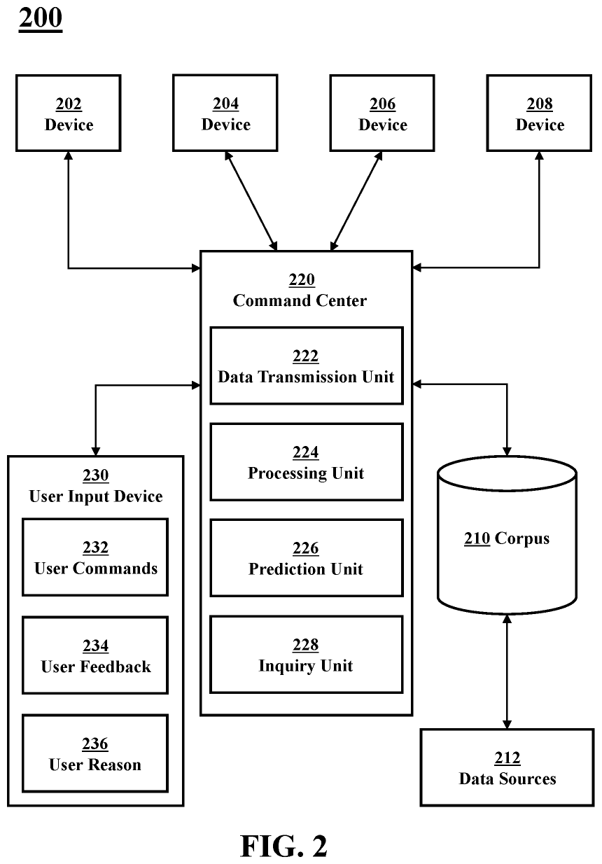

In some embodiments, a smart ecosystem may include several devices (e.g., IoT devices) receiving user commands via a smart hub. FIG. 2 depicts an orchestration flow of a smart ecosystem with curiosity-based self-learning 200 in accordance with such embodiments of the present disclosure.

Several devices 202-208 may be in communication with a command center 220 (e.g., a smart system hub, server, et cetera). Devices 202-208 may be identical (e.g., the same exact item), similar (e.g., different types of item used for a common purpose), unique (e.g., each device performing different functions), or some combination thereof (e.g., two of the same device, one similar device, and one unique device). For example, device 202 and device 204 may both be standing lamps, device 206 may be a flexible light strip installed under cabinets, and device 208 may be an alarm clock. The devices 202-208 may collect data based on integrated sensors, user commands, and/or other mechanisms for gathering information.

The devices 202-208 may communicate with a command center 220. The command center 220 may have a data transmission unit 222 for transmitting data between the command center 220 and other components of the system. The command center 220 may also have a processing unit 224 (e.g., a processor) for processing information. The command center 220 may also have a prediction unit 226 for predicting and anticipating user commands based on input data. The command center 220 may also have an inquiry unit 228 for prompting a user for reasons for certain submitted commands and/or anticipated commands that were not submitted.

The data transmission unit 222 may facilitate communications between the command center 220 and various other components in the system. The data transmission unit 222 may, for example, submit user commands to one or more of the relevant devices 202-208 (e.g., submitting a command to add an alarm to the alarm clock). The data transmission unit 222 may also submit data gathered from user input, sensory collection, command history, and the like to a corpus 210 for storage and/or use by the prediction unit 226 to formulate predictions.

The command center 220 may collect data from devices 202-208 and a user input device 230 to submit to the corpus 210. The corpus 210 may also collect data from one or more external data sources 212. External data sources 212 may include, for example, websites, programs, applications, public data stores, one or more affiliated user profiles, public profiles of similar users, books, other publications, external devices, or other source of information. External data sources 212 may, for example, provide weather data such as current conditions and expectations for later weather conditions. In some embodiments, a user may opt to link one or more social media profiles to the corpus 210 to provide user insights. In some embodiments, a user may link a music and/or video streaming service to provide data about what kind of music the user is listening to or what show a user is watching.

A user may also contribute data to the system via a user input device 230. The user input device 230 may include modules for user commands 232, user feedback 234, and/or user reason 236. A user may use a user input device 232 to issue commands to the command center 220 via the module for user commands 232. A user may provide feedback to the system (e.g., indicate that the system correctly or incorrectly anticipated a command) via the module for user feedback 234. A user may provide information to the system as to why the user submitted a command via a module for user reason 236.

Data the user provides via the user input device 230 may be transmitted through the command center 220 to one or more devices 202-208 and/or the corpus 210. The data stored in the corpus 210 may be used by the prediction unit 226 to improve predictions of user commands, increasing the confidence score of predictions.

A smart ecosystem with curiosity-based self-learning may accept input data in any number of ways including, but not limited to, text input, physical gestures, and vocal commands, including, for example, natural language commands.

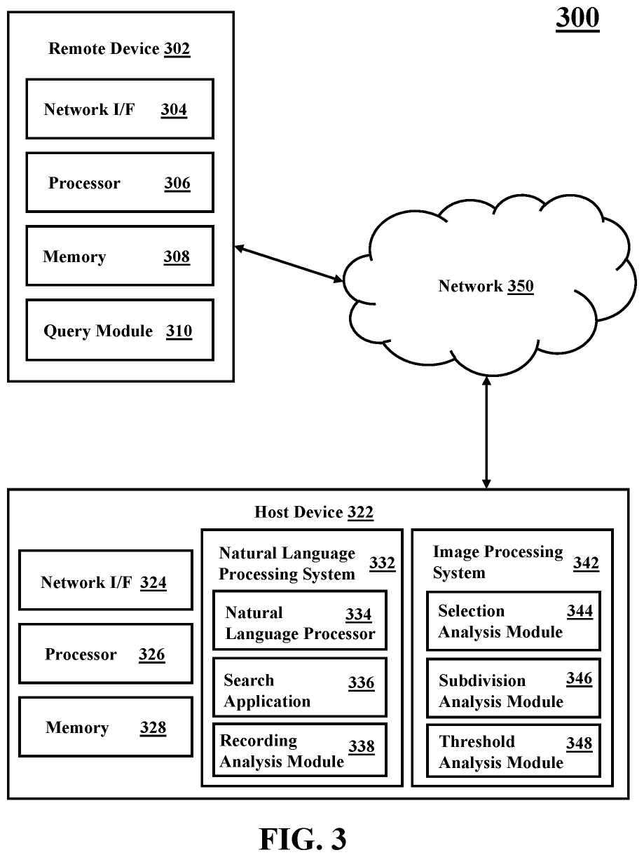

Some embodiments of the present disclosure may utilize a natural language parsing and/or subparsing component. Thus, aspects of the disclosure may relate to natural language processing. Accordingly, an understanding of the embodiments of the present invention may be aided by describing embodiments of natural language processing systems and the environments in which these systems may operate. Turning now to FIG. 3, illustrated is a block diagram of an example computing environment 300 in which illustrative embodiments of the present disclosure may be implemented. In some embodiments, the computing environment 300 may include a remote device 302 and a host device 322.

Consistent with various embodiments of the present disclosure, the host device 322 and the remote device 302 may be computer systems. The remote device 302 and the host device 322 may include one or more processors 306 and 326 and one or more memories 308 and 328, respectively. The remote device 302 and the host device 322 may be configured to communicate with each other through an internal or external network interface 304 and 324. The network interfaces 304 and 324 may be modems or network interface cards. The remote device 302 and/or the host device 322 may be equipped with a display such as a monitor. Additionally, the remote device 302 and/or the host device 322 may include optional input devices (e.g., a keyboard, mouse, scanner, or other input device) and/or any commercially available or custom software (e.g., browser software, communications software, server software, natural language processing software, search engine and/or web crawling software, filter modules for filtering content based upon predefined parameters, etc.). In some embodiments, the remote device 302 and/or the host device 322 may be servers, desktops, laptops, or hand-held devices.

The remote device 302 and the host device 322 may be distant from each other and communicate over a network 350. In some embodiments, the host device 322 may be a central hub from which remote device 302 can establish a communication connection, such as in a client-server networking model. Alternatively, the host device 322 and remote device 302 may be configured in any other suitable networking relationship (e.g., in a peer-to-peer configuration or using any other network topology).

In some embodiments, the network 350 can be implemented using any number of any suitable communications media. For example, the network 350 may be a wide area network (WAN), a local area network (LAN), an internet, or an intranet. In certain embodiments, the remote device 302 and the host device 322 may be local to each other and communicate via any appropriate local communication medium. For example, the remote device 302 and the host device 322 may communicate using a local area network (LAN), one or more hardwire connections, a wireless link or router, or an intranet. In some embodiments, the remote device 302 and the host device 322 may be communicatively coupled using a combination of one or more networks and/or one or more local connections. For example, the remote device 302 may be hardwired to the host device 322 (e.g., connected with an Ethernet cable) or the remote device 302 may communicate with the host device using the network 350 (e.g., over the Internet).

In some embodiments, the network 350 can be implemented within a cloud computing environment or using one or more cloud computing services. Consistent with various embodiments, a cloud computing environment may include a network-based, distributed data processing system that provides one or more cloud computing services. Further, a cloud computing environment may include many computers (e.g., hundreds or thousands of computers or more) disposed within one or more data centers and configured to share resources over the network 350.

In some embodiments, the remote device 302 may enable a user to input (or may input automatically with or without a user) a query to the host device 322 in order to identify subdivisions of a recording that include a particular subject. For example, the remote device 302 may include a query module 310 and a user interface (UI). The query module 310 may be in the form of a web browser or any other suitable software module, and the UI may be any type of interface (e.g., command line prompts, menu screens, graphical user interfaces). The UI may allow a user to interact with the remote device 302 to input, using the query module 310, a query to the host device 322, which may receive the query.

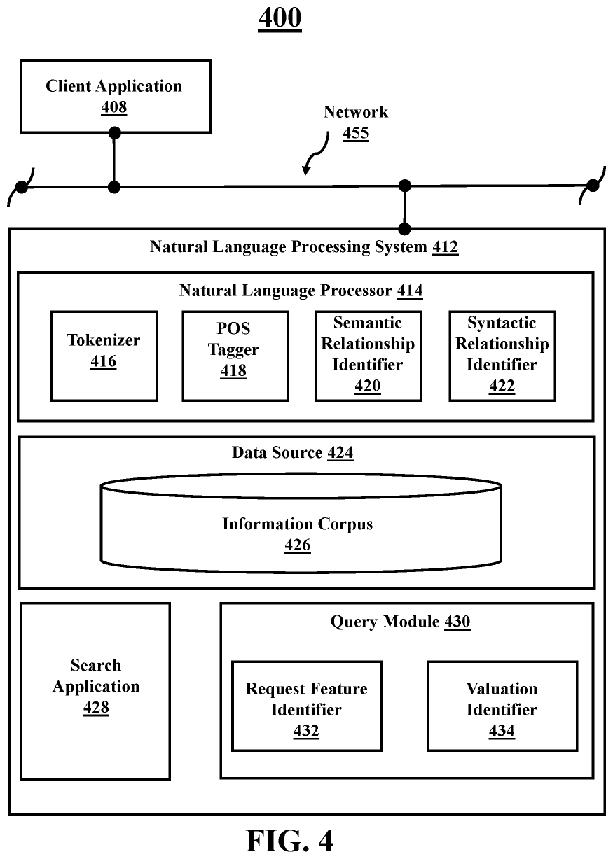

In some embodiments, the host device 322 may include a natural language processing system 332. The natural language processing system 332 may include a natural language processor 334, a search application 336, and a recording module 338. The natural language processor 334 may include numerous subcomponents, such as a tokenizer, a part-of-speech (POS) tagger, a semantic relationship identifier, and a syntactic relationship identifier. An example natural language processor is discussed in more detail in reference to FIG. 4.

The search application 336 may be implemented using a conventional or other search engine and may be distributed across multiple computer systems. The search application 336 may be configured to search one or more databases (e.g., repositories) or other computer systems for content that is related to a query submitted by the remote device 302. For example, the search application 336 may be configured to search dictionaries, papers, and/or archived reports to help identify a particular subject related to a query provided for a user-requested video. The recording analysis module 338 may be configured to analyze a recording to identify a particular subject (e.g., of the query). The recording analysis module 338 may include one or more modules or units, and may utilize the search application 336, to perform its functions (e.g., to identify a particular subject in a recording), as discussed in more detail in reference to FIG. 4.

In some embodiments, the host device 322 may include an image processing system 342. The image processing system 342 may be configured to analyze images associated with a recording to create an image analysis. The image processing system 342 may utilize one or more models, modules, or units to perform its functions (e.g., to analyze the images associated with the recording and generate an image analysis). For example, the image processing system 342 may include one or more image processing models that are configured to identify specific images related to a recording. The image processing models may include a section analysis module 344 to analyze single images associated with the recording and to identify the location of one or more features of the single images. As another example, the image processing system 342 may include a subdivision module 346 to group multiple images together identified to have a common feature of the one or more features. In some embodiments, image processing modules may be implemented as software modules. For example, the image processing system 342 may include a section analysis module and a subdivision analysis module. In some embodiments, a single software module may be configured to analyze the image(s) using image processing models.

In some embodiments, the image processing system 342 may include a threshold analysis module 348. The threshold analysis module 348 may be configured to compare the instances of a particular subject identified in a subdivision of sections of the recording against a threshold number of instances. The threshold analysis module 348 may then determine if the subdivision should be displayed to a user.

In some embodiments, the host device may have an optical character recognition (OCR) module. The OCR module may be configured to receive a recording sent from the remote device 302 and perform optical character recognition (or a related process) on the recording to convert it into machine-encoded text so that the natural language processing system 332 may perform NLP on the report. For example, a remote device 302 may transmit a video related to a user-requested query to the host device 322. The OCR module may convert the video into machine-encoded text and then the converted video may be sent to the natural language processing system 332 for analysis. In some embodiments, the OCR module may be a subcomponent of the natural language processing system 332. In other embodiments, the OCR module may be a standalone module within the host device 322. In still other embodiments, the OCR module may be located on the remote device 302 and may perform OCR on the recording before the recording is sent to the host device 322.

While FIG. 3 illustrates a computing environment 300 with a single host device 322 and a remote device 302, suitable computing environments for implementing embodiments of this disclosure may include any number of remote devices and host devices. The various models, modules, systems, and components illustrated in FIG. 3 may exist, if at all, across a plurality of host devices and remote devices. For example, some embodiments may include two host devices. The two host devices may be communicatively coupled using any suitable communications connection (e.g., using a WAN, a LAN, a wired connection, an intranet, or the Internet). The first host device may include a natural language processing system configured to receive and analyze a video, and the second host device may include an image processing system configured to receive and analyze .GIFS to generate an image analysis.

It is noted that FIG. 3 is intended to depict the representative major components of an exemplary computing environment 300. In some embodiments, however, individual components may have greater or lesser complexity than as represented in FIG. 3, components other than or in addition to those shown in FIG. 3 may be present, and the number, type, and configuration of such components may vary.

Referring now to FIG. 4, shown is a block diagram of an exemplary system architecture 400 including a natural language processing system 412 configured to analyze data to identify objects of interest, in accordance with embodiments of the present disclosure. In some embodiments, a remote device (such as remote device 302 of FIG. 3) may submit a text segment and/or a corpus to be analyzed to the natural language processing system 412 which may be housed on a host device (such as host device 322 of FIG. 3). Such a remote device may include a client application 408, which may itself involve one or more entities operable to generate or modify information associated with the recording and/or query that is then dispatched to a natural language processing system 412 via a network 455.

Consistent with various embodiments of the present disclosure, the natural language processing system 412 may respond to text segment and corpus submissions sent by a client application 408. Specifically, the natural language processing system 412 may analyze a received text segment and/or corpus to identify an object of interest. In some embodiments, the natural language processing system 412 may include a natural language processor 414, data sources 424, a search application 428, and a query module 430. The natural language processor 414 may be a computer module that analyzes the recording and the query. The natural language processor 414 may perform various methods and techniques for analyzing recordings and/or queries (e.g., syntactic analysis, semantic analysis, etc.). The natural language processor 414 may be configured to recognize and analyze any number of natural languages. In some embodiments, the natural language processor 414 may group one or more sections of a text into one or more subdivisions. Further, the natural language processor 414 may include various modules to perform analyses of text or other forms of data (e.g., recordings, etc.). These modules may include, but are not limited to, a tokenizer 416, a part-of-speech (POS) tagger 418 (e.g., which may tag each of the one or more sections of text in which the particular object of interest is identified), a semantic relationship identifier 420, and a syntactic relationship identifier 422.

In some embodiments, the tokenizer 416 may be a computer module that performs lexical analysis. The tokenizer 416 may convert a sequence of characters (e.g., images, sounds, etc.) into a sequence of tokens. A token may be a string of characters included in a recording and categorized as a meaningful symbol. Further, in some embodiments, the tokenizer 416 may identify word boundaries in a body of text and break any text within the body of text into their component text elements, such as words, multiword tokens, numbers, and punctuation marks. In some embodiments, the tokenizer 416 may receive a string of characters, identify the lexemes in the string, and categorize them into tokens.

Consistent with various embodiments, the POS tagger 418 may be a computer module that marks up a word in a recording to correspond to a particular part of speech. The POS tagger 418 may read a passage or other text in natural language and assign a part of speech to each word or other token. The POS tagger 418 may determine the part of speech to which a word (or other spoken element) corresponds based on the definition of the word and the context of the word. The context of a word may be based on its relationship with adjacent and related words in a phrase, sentence, or paragraph. In some embodiments, the context of a word may be dependent on one or more previously analyzed body of texts and/or corpora (e.g., the content of one text segment may shed light on the meaning of one or more objects of interest in another text segment). Examples of parts of speech that may be assigned to words include, but are not limited to, nouns, verbs, adjectives, adverbs, and the like. Examples of other part of speech categories that POS tagger 418 may assign include, but are not limited to, comparative or superlative adverbs, wh-adverbs, conjunctions, determiners, negative particles, possessive markers, prepositions, wh-pronouns, and the like. In some embodiments, the POS tagger 418 may tag or otherwise annotate tokens of a recording with part of speech categories. In some embodiments, the POS tagger 418 may tag tokens or words of a recording to be parsed by the natural language processing system 412.

In some embodiments, the semantic relationship identifier 420 may be a computer module that may be configured to identify semantic relationships of recognized subjects (e.g., words, phrases, images, etc.) in a body of text/corpus. In some embodiments, the semantic relationship identifier 420 may determine functional dependencies between entities and other semantic relationships.

Consistent with various embodiments, the syntactic relationship identifier 422 may be a computer module that may be configured to identify syntactic relationships in a body of text/corpus composed of tokens. The syntactic relationship identifier 422 may determine the grammatical structure of sentences such as, for example, which groups of words are associated as phrases and which word is the subject or object of a verb. The syntactic relationship identifier 422 may conform to formal grammar.

In some embodiments, the natural language processor 414 may be a computer module that may group sections of a recording into subdivisions and generate corresponding data structures for one or more subdivisions of the recording. For example, in response to receiving a text segment at the natural language processing system 412, the natural language processor 414 may output subdivisions of the text segment as data structures. In some embodiments, a subdivision may be represented in the form of a graph structure. To generate the subdivision, the natural language processor 414 may trigger computer modules 416-422.

In some embodiments, the output of natural language processor 414 may be used by search application 428 to perform a search of a set of (i.e., one or more) corpora to retrieve one or more subdivisions including a particular subject associated with a query (e.g., in regard to an object of interest) and send the output to an image processing system and to a comparator. As used herein, a corpus may refer to one or more data sources, such as a data source 424 of FIG. 4. In some embodiments, data sources 424 may include video libraries, data warehouses, information corpora, data models, and/or document repositories. In some embodiments, the data sources 424 may include an information corpus 426. The information corpus 426 may enable data storage and retrieval. In some embodiments, the information corpus 426 may be a subject repository that houses a standardized, consistent, clean, and integrated list of images and text. For example, an information corpus 426 may include teaching presentations that include step by step images and comments on how to perform a function. Data may be sourced from various operational systems. Data stored in an information corpus 426 may be structured in a way to specifically address reporting and analytic requirements. In some embodiments, an information corpus 426 may be a relational database.

In some embodiments, a query module 430 may be a computer module that identifies objects of interest within sections of a text, or other forms of data. In some embodiments, a query module 430 may include a request feature identifier 432 and a valuation identifier 434. When a query is received by the natural language processing system 412, the query module 430 may be configured to analyze text using natural language processing to identify an object of interest. The query module 430 may first identity one or more objects of interest in the text using the natural language processor 414 and related subcomponents 416-422. After identifying the one or more objects of interest, the request feature identifier 432 may identify one or more common objects of interest present in sections of the text (e.g., the one or more text segments of the text). In some embodiments, the common objects of interest in the sections may be the same object of interest that is identified. Once a common object of interest is identified, the request feature identifier 432 may be configured to transmit the text segments that include the common object of interest to an image processing system (shown in FIG. 3) and/or to a comparator.

After identifying common objects of interest using the request feature identifier 432, the query module may group sections of text having common objects of interest. The valuation identifier 434 may then provide a value to each text segment indicating how close the object of interest in each text segment came to answering a user's query. In some embodiments, the particular subject may have one or more of the common objects of interest identified in the one or more sections of text. After identifying a particular object of interest relating to the query, the valuation identifier 434 may be configured to transmit the criterion to an image processing system (shown in FIG. 3) and/or to a comparator.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly release to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but the consumer has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software which may include operating systems and applications. The consumer does not manage or control the underlying cloud infrastructure but has control over operating systems, storage, and deployed applications, and the consumer possibly has limited control of select networking components (e.g., host firewalls).

Deployment models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and/or compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

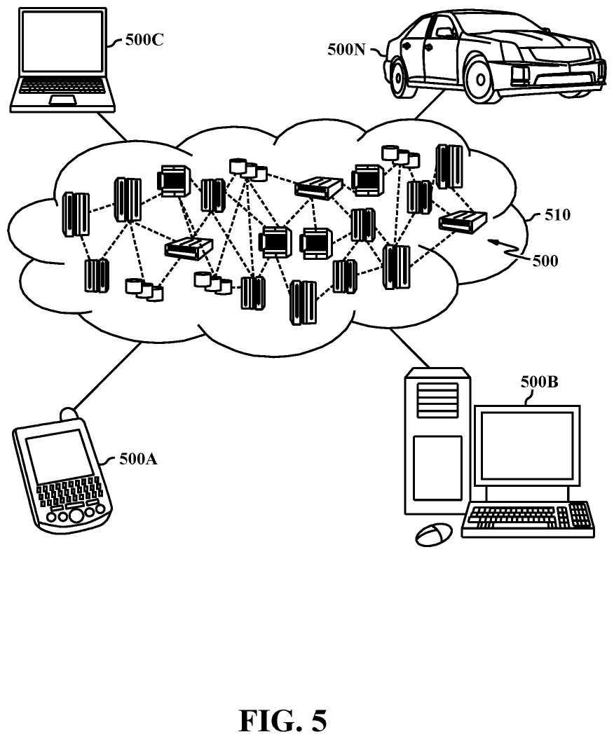

FIG. 5 illustrates a cloud computing environment 510 in accordance with embodiments of the present disclosure. As shown, cloud computing environment 510 includes one or more cloud computing nodes 500 with which local computing devices used by cloud consumers such as, for example, personal digital assistant (PDA) or cellular telephone 500A, desktop computer 500B, laptop computer 500C, and/or automobile computer system 500N may communicate. Nodes 500 may communicate with one another. They may be grouped (not shown) physically or virtually, in one or more networks, such as private, community, public, or hybrid clouds as described hereinabove, or a combination thereof.

This allows cloud computing environment 510 to offer infrastructure, platforms, and/or software as services for which a cloud consumer does not need to maintain resources on a local computing device. It is understood that the types of computing devices 500A-N shown in FIG. 5 are intended to be illustrative only and that computing nodes 500 and cloud computing environment 510 can communicate with any type of computerized device over any type of network and/or network addressable connection (e.g., using a web browser).

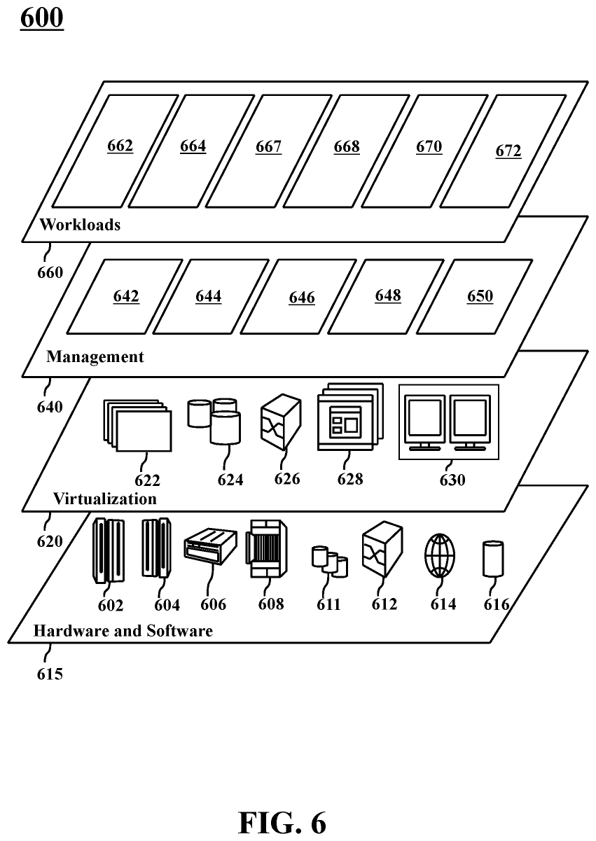

FIG. 6 illustrates abstraction model layers 600 provided by cloud computing environment 510 (of FIG. 5) in accordance with embodiments of the present disclosure. It should be understood in advance that the components, layers, and functions shown in FIG. 6 are intended to be illustrative only and embodiments of the disclosure are not limited thereto. As depicted below, the following layers and corresponding functions are provided.

Hardware and software layer 615 includes hardware and software components. Examples of hardware components include: mainframes 602; RISC (Reduced Instruction Set Computer) architecture-based servers 604; servers 606; blade servers 608; storage devices 611; and networks and networking components 612. In some embodiments, software components include network application server software 614 and database software 616.

Virtualization layer 620 provides an abstraction layer from which the following examples of virtual entities may be provided: virtual servers 622; virtual storage 624; virtual networks 626, including virtual private networks; virtual applications and operating systems 628; and virtual clients 630.

In one example, management layer 640 may provide the functions described below. Resource provisioning 642 provides dynamic procurement of computing resources and other resources that are utilized to perform tasks within the cloud computing environment. Metering and pricing 644 provide cost tracking as resources and are utilized within the cloud computing environment as well as billing or invoicing for consumption of these resources. In one example, these resources may include application software licenses. Security provides identity verification for cloud consumers and tasks as well as protection for data and other resources. User portal 646 provides access to the cloud computing environment for consumers and system administrators. Service level management 648 provides cloud computing resource allocation and management such that required service levels are met. Service level agreement (SLA) planning and fulfillment 650 provide pre-arrangement for, and procurement of, cloud computing resources for which a future requirement is anticipated in accordance with an SLA.

Workloads layer 660 provides examples of functionality for which the cloud computing environment may be utilized. Examples of workloads and functions which may be provided from this layer include: mapping and navigation 662; software development and lifecycle management 664; virtual classroom education delivery 667; data analytics processing 668; transaction processing 670; and one or more smart ecosystems with curiosity-based self-learning 672.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment currently known or which may be later developed.

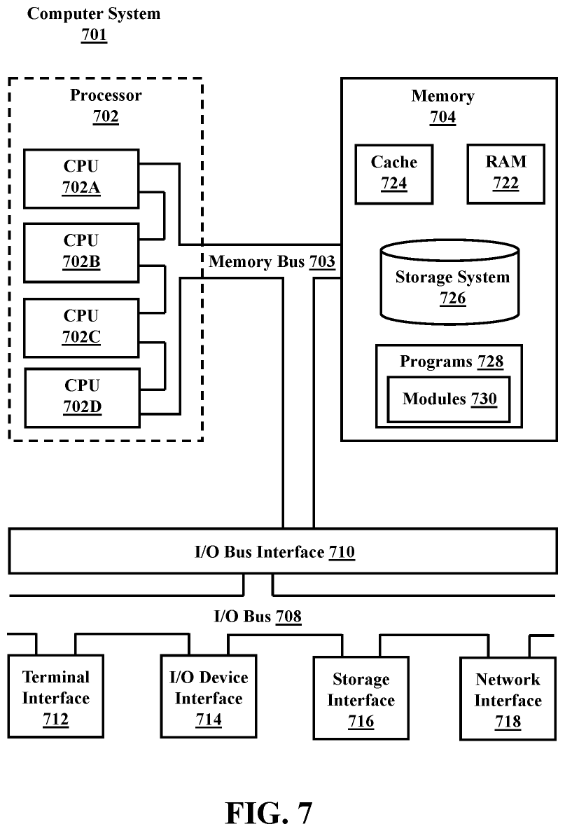

FIG. 7 illustrates a high-level block diagram of an example computer system 701 that may be used in implementing one or more of the methods, tools, and modules, and any related functions, described herein (e.g., using one or more processor circuits or computer processors of the computer) in accordance with embodiments of the present disclosure. In some embodiments, the major components of the computer system 701 may comprise a processor 702 with one or more central processing units (CPUs) 702A, 702B, 702C, and 702D, a memory subsystem 704, a terminal interface 712, a storage interface 716, an I/O (Input/Output) device interface 714, and a network interface 718, all of which may be communicatively coupled, directly or indirectly, for inter-component communication via a memory bus 703, an I/O bus 708, and an I/O bus interface unit 710.

The computer system 701 may contain one or more general-purpose programmable CPUs 702A, 702B, 702C, and 702D, herein generically referred to as the CPU 702. In some embodiments, the computer system 701 may contain multiple processors typical of a relatively large system; however, in other embodiments, the computer system 701 may alternatively be a single CPU system. Each CPU 702 may execute instructions stored in the memory subsystem 704 and may include one or more levels of on-board cache.

System memory 704 may include computer system readable media in the form of volatile memory, such as random access memory (RAM) 722 or cache memory 724. Computer system 701 may further include other removable/non-removable, volatile/non-volatile computer system storage media. By way of example only, storage system 726 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM, or other optical media can be provided. In addition, memory 704 can include flash memory, e.g., a flash memory stick drive or a flash drive. Memory devices can be connected to memory bus 703 by one or more data media interfaces. The memory 704 may include at least one program product having a set (e.g., at least one) of program modules that are configured to carry out the functions of various embodiments.

One or more programs/utilities 728, each having at least one set of program modules 730, may be stored in memory 704. The programs/utilities 728 may include a hypervisor (also referred to as a virtual machine monitor), one or more operating systems, one or more application programs, other program modules, and program data. Each of the operating systems, one or more application programs, other program modules, and program data, or some combination thereof, may include an implementation of a networking environment. Programs 728 and/or program modules 730 generally perform the functions or methodologies of various embodiments.

Although the memory bus 703 is shown in FIG. 7 as a single bus structure providing a direct communication path among the CPUs 702, the memory subsystem 704, and the I/O bus interface 710, the memory bus 703 may, in some embodiments, include multiple different buses or communication paths, which may be arranged in any of various forms, such as point-to-point links in hierarchical, star, or web configurations, multiple hierarchical buses, parallel and redundant paths, or any other appropriate type of configuration. Furthermore, while the I/O bus interface 710 and the I/O bus 708 are shown as single respective units, the computer system 701 may, in some embodiments, contain multiple I/O bus interface units 710, multiple I/O buses 708, or both. Further, while multiple I/O interface units 710 are shown, which separate the I/O bus 708 from various communications paths running to the various I/O devices, in other embodiments some or all of the I/O devices may be connected directly to one or more system I/O buses 708.

In some embodiments, the computer system 701 may be a multi-user mainframe computer system, a single-user system, a server computer, or similar device that has little or no direct user interface but receives requests from other computer systems (clients). Further, in some embodiments, the computer system 701 may be implemented as a desktop computer, portable computer, laptop or notebook computer, tablet computer, pocket computer, telephone, smartphone, network switches or routers, or any other appropriate type of electronic device.

It is noted that FIG. 7 is intended to depict the representative major components of an exemplary computer system 701. In some embodiments, however, individual components may have greater or lesser complexity than as represented in FIG. 7, components other than or in addition to those shown in FIG. 7 may be present, and the number, type, and configuration of such components may vary.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide, or other transmission media (e.g., light pulses passing through a fiber-optic cable) or electrical signals transmitted through a wire.

Computer readable program instructions described herein can be downloaded to respective computing/processing devices from a computer readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN) or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions which comprises one or more executable instructions for implementing the specified logical function(s). In some alternative implementations, the functions noted in the blocks may occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although the present disclosure has been described in terms of specific embodiments, it is anticipated that alterations and modification thereof will become apparent to the skilled in the art. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application, or the technical improvement over technologies found in the marketplace or to enable others of ordinary skill in the art to understand the embodiments disclosed herein. Therefore, it is intended that the following claims be interpreted as covering all such alterations and modifications as fall within the true spirit and scope of the disclosure.

1. A method for curiosity-based self-learning of a smart ecosystem, said method comprising:
receiving, by a processor, a submission of a command;
analyzing said command for at least one commonality with a previous command;
predicting a predicted reason for said submission of said command based on historical learning; and
integrating said predicted reason into a corpus specific to a user, wherein said corpus includes user preference data, and wherein said processor predicts one or more orders of said user using said corpus.

2. The method of claim 1 further comprising:
prompting said user for a validated reason, wherein said validated reason overwrites said predicted reason in said corpus.

3. The method of claim 1 further comprising:
receiving feedback from said user; and
incorporating said feedback into said corpus.

4. The method of claim 3 further comprising:
requesting said feedback from said user in response to said user not requesting said one or more orders predicted by said processor.

5. The method of claim 1 wherein:
said processor is a smart device which is part of an internet of things device network; and
said internet of things device network uses historical learning from an internet of things data feed.

6. The method of claim 1 further comprising:
prompting said user for a predicted command based on said corpus.

7. The method of claim 6 further comprising:
adapting to said feedback by adjusting frequency of requests for said feedback.

8. The method of claim 1 further comprising:
incorporating mood analysis into said predicted reason.

9. The method of claim 1 wherein:
said analyzing said command to identify at least one commonality with a previous command includes identifying a contextual scenario.

10. A system for a curiosity-based self-learning smart ecosystem, said system comprising:
a memory; and
a processor in communication with said memory, said processor being configured to perform operations comprising:
receiving, by said processor, a submission of a command;
analyzing said command to identify at least one commonality with a previous command;
predicting a predicted reason for said submission of said command based on historical learning; and
integrating said predicted reason into a corpus specific to a user wherein said corpus comprises user preference data;
wherein said smart device predicts one or more orders of said user using said corpus.

11. The system of claim 10 wherein said operations further comprise:
receiving feedback from said user; and
incorporating said feedback into said corpus.

12. The system of claim 11 wherein said operations further comprise:
requesting said feedback from said user in response to said user not requesting said one or more orders predicted by said processor.

13. The system of claim 10 wherein said operations further comprise:
said processor is a smart device which is part of an internet of things device network; and
said internet of things device network uses historical learning from an internet of things data feed.

14. The system of claim 10 wherein said operations further comprise:
prompting said user for a predicted command based on said corpus.

15. The system of claim 14 wherein said operations further comprise:
adapting to said feedback by adjusting frequency of requests for said feedback.

16. The system of claim 10 wherein said operations further comprise:
said analyzing said command to identify at least one commonality with a previous command includes identifying a contextual scenario.

17. A computer program product for curiosity-based self-learning of a smart ecosystem, said computer program product comprising a computer readable storage medium having program instructions embodied therewith, said program instructions executable by a processor to cause said processor to perform a function, said function comprising:
receiving, by said processor, a submission of a command;
analyzing said command to identify at least one commonality with a previous command;
predicting a predicted reason for said submission of said command based on historical learning; and
integrating said predicted reason into a corpus specific to a user wherein said corpus comprises user preference data;
wherein said smart device predicts one or more orders of said user using said corpus.

18. The computer program product of claim 17 wherein said function further comprises:
receiving feedback from said user; and
incorporating said feedback into said corpus.

19. The computer program product of claim 18 wherein said function further comprises:
requesting said feedback from said user in response to said user not requesting said one or more orders predicted by said processor.

20. The computer program product of claim 17 wherein said function further comprises:
said analyzing said command to identify at least one commonality with a previous command includes identifying a contextual scenario.
